(19) United States
(12) Patent Application Publication
(10) Pub. No.: US 2008/0274647 A1
(43) Pub. Date: Nov. 6, 2008

(54) Usb Data-Audio Signal Multiplexing Transmission Line

(76) Inventors: Hsuan-ming Shih, Shen Zhen City (CN); Dezhong Zhu, Shen Zhen City (CN)

Correspondence Address: GREER, BURNS & CRAIN, 300 S WACKER DR, 25TH FLOOR, CHICAGO, IL, 60606, US

(21) Appl. No.: 11/910,585

(22) PCT Filed: Mar. 23, 2006
(86) PCT No.: PCT/CN2006/000473

§ 371 Date: Jun. 12, 2008

(30) Foreign Application Priority Data
Apr. 13, 2005 (CN) 200510063571.0

(51) Int. Cl. H01R 31/06

(52) U.S. Cl. 439/628

(57) ABSTRACT

A USB data-audio signal multiplexing transmission line includes a USB connector and an audio connector on two ends and a transmission wire for connecting a play device to another external data storage device or processing device to make data exchange or output audio signal. An audio connecting plug set on the audio connector is divided into four electric independent segments which are two audio signal connecting ends, an audio ground connecting end and a control signal connecting end in turn. The two audio signal connecting ends of the audio connecting plug are connected to the two data signal connecting ends of the USB connecting plug, the ground connecting end of the audio connecting plug is connected to a ground connecting end of the USB connecting plug, the control signal end of the audio connecting plug is connected to a power end of the USB connecting plug.

### FIELD OF THE INVENTION

The present invention relates to a multiplexing transmission line, especially to a USB data-audio signal multiplexing transmission line.

### BACKGROUND OF THE INVENTION

Along with the continuous development of electronic technology, the consumptive electronics has been used more and more widely, for example, various electronic devices, such as MP3, DV, PDA, handset, game device etc., which can not only download data from a data sources, but also transmit data to store them into another storage devices, for instance transmitting the data to a computer to store them. Such devices need special interface to be connected with another data sources or storage devices when transmitting data. At present the USB interface is generally used. When audio data are played, an audio output device should be connected to the aforesaid devices by audio interface, and the audio data in aforesaid video audio player are played through the audio output device. The audio output device can be earphone, speaker or other device with playing function. Therefore, to realize data-transmitting and audio-outputting, the existing electronic devices must be set with USB interface and audio interface simultaneously. And the transmission line with the different interfaces is also needed when connecting the devices with different interfaces to each other. Special interfaces as well as special lines are required by the intercommunication between different electronic devices and transmission line with different function should be selected, when users connect the small electronic device they possess to other small mobile electronic device or fixed electronic device to realize the mutual transmission of data or information. This would bring many troubles to users. Concurrently, in spite of the USB plugs being standard plugs, they still have the problem of narrow optional scope when the existing USB plugs are used in conjunction with other devices. And most of the existing USB plugs are exposed designs, which is easy to be polluted and damaged when being stored and used.

### SUMMARY OF THE INVENTION

The object of the present invention is, aiming at the shortcomings of the prior art, to provide a USB data-audio signal multiplexing transmission line which has a USB connecting unit and an audio connecting unit respectively in two ends thereof to transmit data signal via USB interface and transmit audio signal via audio input /output interface to realize the connection of devices with different interfaces.

Another object of the present invention is, aiming at the shortcomings of the prior art, to provide a USB data-audio signal multiplexing transmission line, the USB plug of which can be protected by adopting various hidden structures which are simple and convenient to use, such as rotary, extensile or overturn structures.

To realize above objects, the present invention provides a USB data-audio signal multiplexing transmission line, comprising connectors in both ends and a transmission wire for connecting a playing device to another external data storage device or processing device to make data exchange or output audio signal. The connectors in both ends are respectively a USB connector and an audio connector. The USB connector includes a connector body and a flaky USB connecting plug set on the body. An audio connecting plug set on the audio connector is divided into four electric-independent segments which are two audio signal connecting ends, an audio ground connecting end and a control signal connecting end in turn. The two audio signal connecting ends of the audio connecting plug are connected to two data signal connecting ends of the flaky USB connecting plug respectively, the ground connecting end of the audio connecting plug is connected to a ground connecting end of the flaky USB connecting plug, and the control signal connecting end of the audio connecting plug is connected to a power end of the USB connecting plug.

Said USB connector body can comprise a shell and a rotary body. The flaky USB connecting plug is set on an end portion of the rotating body. The shell, with a perforation opened at the tail end through which the transmission wire is set, covers the rotating body. The rotary body is pin-jointed at the front end of the shell and rotates around a pin-jointed point. Two sides of the shell serve as opens for the rotary body rotating through.

Said USB connector body can also comprise a shell and an extension body. The flaky USB connecting plug is set on an end portion of the extension body. The shell, with a perforation opened at the tail end through which the transmission wire is set, covers the extension body. The shell is set outside the extension body to cover the extension body. A bulge portion is located on an upper surface of the extension body and a slide groove is cut on the upper surface of the shell. The bulge portion is embedded in the slide groove and slides along the slide groove to make the extension body flex in the shell.

Said USB connector body can also comprise a combination body and an overturn body. One end of the combination body is pin-jointed to the overturn body and the other end is connected to the transmission wire. A flaky USB connecting plug is set on the non-pin-jointed end of the overturn body. A groove is cut on the upper surface of the combination body and shape and size of the groove are corresponding to those of the overturn body.

For conveniently multiplex use, an audio interface is set in the combination body.

The USB connector can comprise a printed circuit board and an integrative-disposed USB interface connecting board. The printed circuit board is located inside the connector body and the USB interface connecting board protrudes from the connector body and forms the flaky USB connecting plug together with a projecting bottom shell of the connector body. There is a set of metal terminals located on the connecting board. The set of metal terminals consists of several metal sheets for connecting with the electronic signal in the USB slot; the metal sheets are coupled to the printed circuit board and form a circuit loop. A protrusion-strip-shaped protection frame sticks up from two sides of the bottom shell of the USB connecting plug. The USB interface connecting board is embedded into the bottom shell, with the side having the set of metal terminals upward as an exposed face. The size of the flaky USB connecting plug is same as that of inner space of the USB wire slot.

The setting range of the metal sheets of the set of metal terminals is same as the length of the projecting USB interface connecting board, and the length of the metal sheets is same as or longer than that of a contact sheet for electrical connection inside the USB slot.

Four metal sheets, coupled to a power wire, two data wires and a ground wire inside a USB connecting unit in turn, are set on the upper surface of said USB interface connecting board and two metal sheets are set on the lower surface. The middle two metal sheets of the upper surface connect to each other and also connect to two audio signal wires. The protection frame is correspondingly located on both side of the USB interface connecting board; the upper and the lower surfaces of the board body are both exposed.

The set of metal terminals set on the USB interface connecting board is divided into two groups. One group includes four metal sheets coupled to a power wire, two data wires and a ground wire inside a USB connecting unit in turn. The other group includes two metal sheets coupled to two audio signal wires of an audio connecting unit.

For convenient use, the flaky USB connecting plug is plug style or receptacle style. The flaky USB connecting plug is large plug or small plug. Said audio connector is audio plug or audio receptacle.

In summary, the present invention provides a USB data-audio signal multiplexing transmission line, with a USB connecting unit and an audio connecting unit set on two ends respectively. The data signal can be transmitted through the USB interface while the audio signal can be transmitted by the audio input /output interface to realize connection between devices with different interfaces. At the same time, the USB plug of the multiplexing transmission line provided by the present invention can be protected by adopting various hidden structures which are simple and convenient to use, such as rotary, extensile or overturn style structure.

The technical solution of the present invention will be more fully described by the following detailed description of preferred embodiments of the present invention which is to be considered together with the accompanying drawings.

### BRIEF DESCRIPTION OF THE DRAWINGS

FIG. 1 shows a schematic structure diagram of a first embodiment according to the present invention;

FIG. 2 shows a schematic structure diagram of a first state of a second embodiment according to the present invention;

FIG. 3 shows a schematic structure diagram of a second state of the second embodiment according to the present invention;

FIG. 4 shows a schematic structure diagram of a third state of the second embodiment according to the present invention;

FIG. 5 shows a schematic structure diagram of a first state of a third embodiment according to the present invention;

FIG. 6 shows a schematic structure diagram of a second state of the third embodiment according to the present invention;

FIG. 7 shows a schematic structure diagram of a fourth embodiment according to the present invention;

FIG. 8 shows a developing drawing of one end of USB connector in FIG. 7;

FIG. 9 shows a schematic structure diagram of a USB plug according to a fifth embodiment of the present invention;

FIG. 10 shows a schematic structure diagram of a USB plug according to a sixth embodiment of the present invention;

FIG. 11 shows a schematic structure diagram of a USB plug according to a seventh embodiment of the present invention;

FIG. 12 shows a schematic diagram of a first application embodiment of the present invention;

FIG. 13 shows a schematic diagram of a second application embodiment of the present invention.

### DETAILED DESCRIPTION OF THE INVENTION

### The First Embodiment

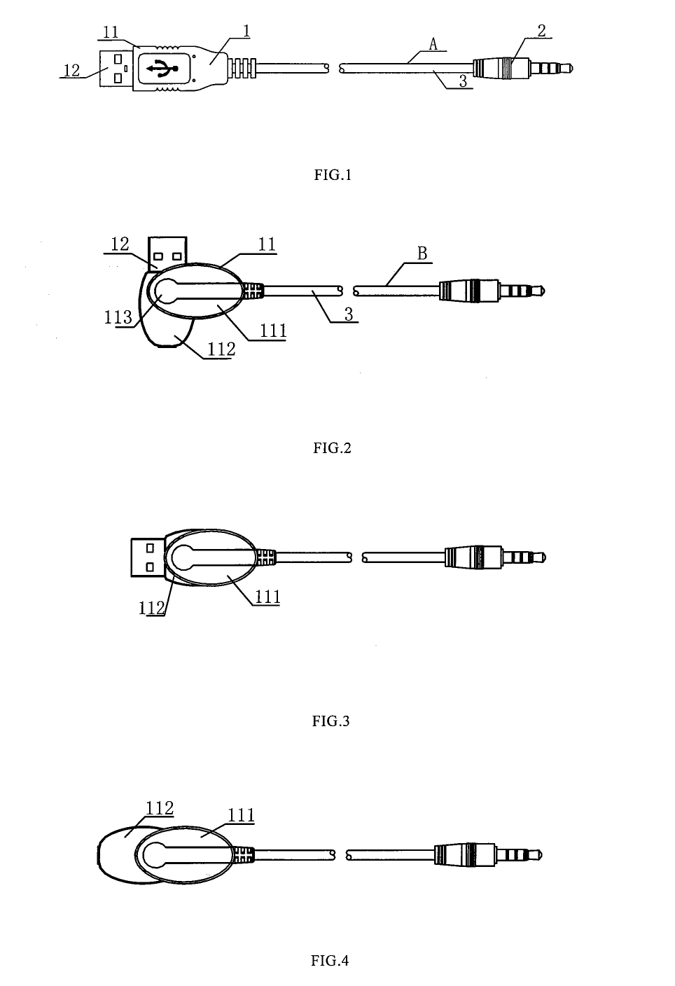

FIG. 1 shows the schematic structure diagram of the first embodiment according to the present invention. It can be seen from FIG. 1 that the present invention relates to a USB data-audio signal multiplexing transmission line A comprising two connectors on both ends as well as the transmission wire 3 for connecting the play device to another external data storage device or processing device and performing data exchange or outputting audio signal. The connectors on both ends are respectively a USB connector 1 and an audio connector 2. The USB connector 1 includes a connector body 11 and a USB connecting plug 12 set on the body. The audio connecting plug located on the audio connector is divided into four electric-independent segments, which are two audio signal connecting ends, an audio ground connecting end and a control signal connecting end. The two audio signal connecting ends of the audio connecting plug connect the two data signal connecting ends of the flaky USB connecting plug respectively, the ground connecting end of the audio connecting plug connects to the ground connecting end of the flaky USB connecting plug, the control signal connecting end of the audio connecting plug connects the power end of the USB connecting plug.

### The Second Embodiment

FIGS. 2-4 are respectively the schematic structure diagrams illustrating three states of the second embodiment according to the present invention. It can be seen from FIG. 2 that this embodiment provides a USB data-audio signal multiplexing transmission line B, wherein the USB connector body 11 could comprise a shell 111 and a rotating body 112. The USB connecting plug 12 is set on an end portion of the rotating body 112. The shell 111, with a perforation opened at the tail end through which the transmission wire 3 is set, covers the rotating body 112. The rotary body 112 is pin-jointed to the front end of the shell 111, and could rotate around the pin-jointed point 113. Two sides of the shell 111 serve as opens for the rotary body 112 rotating through. FIGS. 3 and 4 show respectively the location relationships of the rotary body 112 and the shell 111 when the transmission line B is in in-use state and in unused state. As shown in FIG. 3, the rotary body 112 is rotated around the pin-jointed point 113 to make the USB connecting plug 12 exposed outside the shell 111 when the USB connecting plug is needed. And the rotary body 112 is rotated to make the USB connecting plug 12 hidden in the shell 111 after use.

### The Third Embodiment

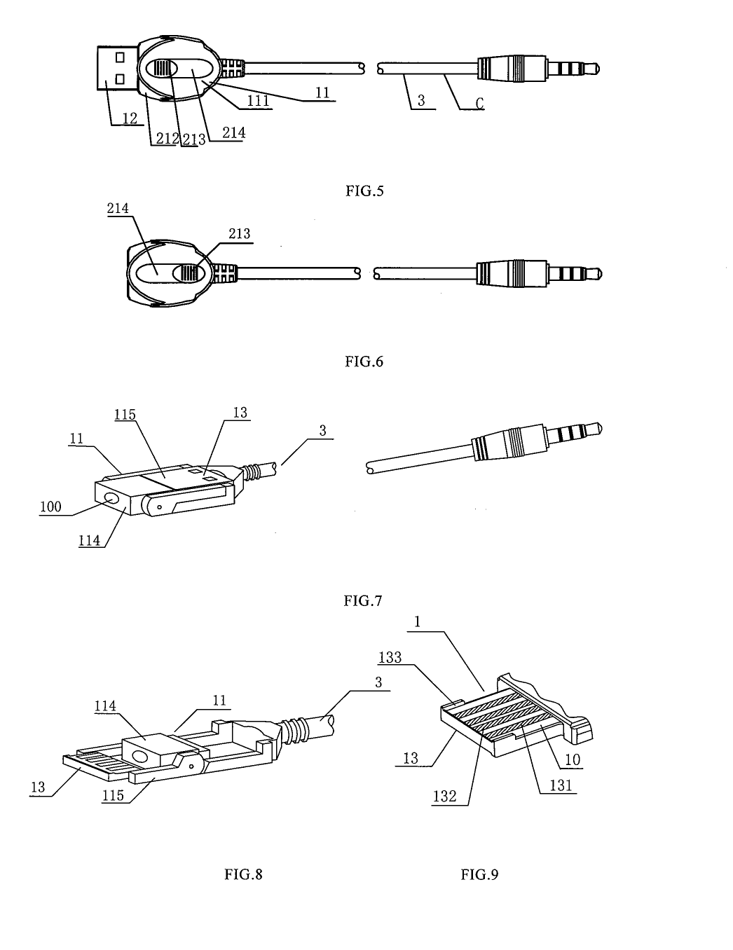

FIGS. 5 and 6 are the schematic structure diagrams illustrating two states of the third embodiment according to the present invention. From FIG. 5, it can be seen that this embodiment provides a USB data-audio signal multiplexing transmission line C, wherein the USB connector body 11 could comprise a shell 111 and an extension body 212. A USB connecting plug 12 is set on the end portion of the extension body 212, and the shell 111, with a perforation opened at the tail end through which the transmission wire 3 is set, covers the extension body 212. The shell 111 is set outside the extension body 212 to cover it. A bulge portion 213 is located on upper surface of the extension body 212, and a slide groove 214 is cut on the upper surface of the shell. The bulge portion 213 is embedded in the slide groove 214 and can slide along the slide groove 214 to make the extension body 212 flex in the shell 111. Combined with FIG. 6, it can be seen that the bulge portion 213 slides along the slide groove 214 to drive the USB connecting plug 12 draw back and the USB connecting plug 12 is hidden into the shell 111 when the USB connecting plug 12 is not used.

### The Fourth Embodiment

FIGS. 7 and 8 are the schematic structure diagrams of the fourth embodiment according to the present invention. It can be seen from FIG. 7 that the USB connector body 11 can also include a combination body 114 and an overturn body 115. One end of the combination body is pin-jointed to the overturn body 115, while another end is connected to the transmission wire 3. A flaky USB connecting plug 13 is set on the non-pin-jointed end of the overturn body 115. A groove is cut on the upper surface of the combination body 114 and the shape and size of the groove are corresponding to those of the overturn body 115. For conveniently multiplex use, an audio interface 100 can also be set in the combination body 114. As shown in FIG. 8, the overturn body 115 can overturn around the combination body 114, to make the flaky USB connecting plug 13 spread out or draw in.

### The Fifth Embodiment

FIG. 9 is the schematic structure diagram of the fifth embodiment according to the present invention. FIG. 9 illustrates that the USB connector 1 includes a printed circuit board and an integrative-disposed USB interface connecting board 10. The printed circuit board is located inside the connector body, and the USB interface connecting board protrudes from the connector body and forms the flaky USB connecting plug 13 with the projecting bottom shell of the connector body. This is shown in FIG. 9. There is a set of metal terminals 131 set on the connecting board. Such set of metal terminals 131 consists of several metal sheets 132 for connecting with the electronic signal in the USB slot, the metal sheets are coupled to the printed circuit board and forming a circuit loop. A protrusion-strip-shaped protection frame 133 sticks up from two sides of the bottom shell of the flaky USB connecting plug 13. The USB interface connecting board is embedded into the bottom shell, with the side having the set of metal terminals 131 upward as an exposed face. The size of the flaky USB connecting plug 13 is same as that of the inner space of the USB wire slot. The setting range of the metal sheets 132 of the set of metal terminals 131 is same as the length of the projecting USB interface connecting board, and the length of the metal sheets 132 is same as or longer than that of the contact sheet for electrical connection inside the USB slot.

### The Sixth Embodiment

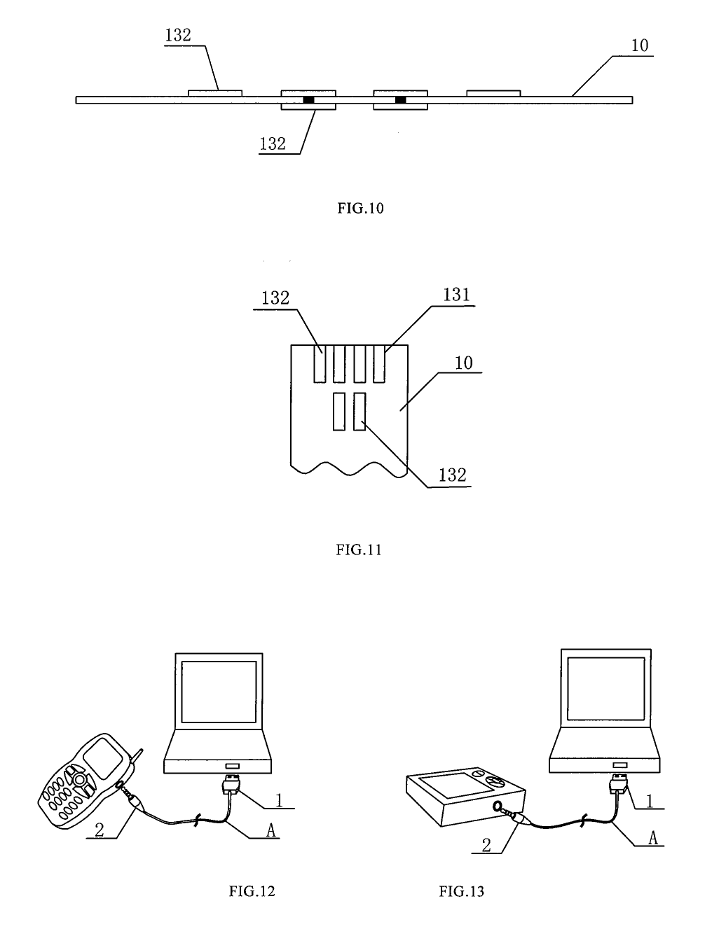

FIG. 10 is the schematic structure diagram of the sixth embodiment according to the present invention. FIG. 10 shows that four metal sheets are disposed on the upper surface of the USB interface connecting board 10, which are coupled to a power wire, the two data wires and the ground wire inside the USB connecting unit in turn. Two metal sheets 132 are set on the lower surface. The middle two metal sheets of the upper surface connect to each other and also connect to the two audio signal wires. The protrusion-stripe-shaped protection frame 133 in the fifth embodiment is correspondingly located on two side of the USB interface connecting board; the upper and lower surfaces of the board body are both exposed.

### The Seventh Embodiment

FIG. 11 is the schematic structure diagram of the seventh embodiment according to the present invention. FIG. 11 shows that the set of metal terminals 131 located on the USB interface board 10 can be divided into two groups, one group includes four metal sheets 132 which are coupled to the power wire, the two data wires and the ground wire inside the USB connecting unit in turn; the other group includes two metal sheets 132 which are coupled to the two audio signal wires of the audio connecting unit.

For convenient use, the flaky USB connecting plug 13 can be plug style or receptacle style. And the flaky USB connecting plug 13 can adopt large plug or small plug. The audio connector 2 can be audio plug or audio receptacle.

### The First Application Embodiment

FIG. 12 is the schematic diagram of the first application embodiment according to the present invention. FIG. 12 illustrates that the USB data-audio signal multiplexing transmission line A provided by the present invention connects to a computer and a handset respectively via the USB connector 1 and the audio connector 2 on both ends to realize data transmission between them.

### The Second Application Embodiment

FIG. 13 is the schematic diagram of the second application embodiment according to the present invention. It can be seen from FIG. 13 that the USB data-audio signal multiplexing transmission line A provided by the present invention connects a computer and a PDA by the USB connector 1 and the audio connector 2 on both ends to realize data transmission between them. The present invention provides a USB data-audio signal multiplexing transmission line, with a USB connecting unit and an audio connecting unit set on the two ends respectively. The data signal can be transmitted through the USB interface while the audio signal can be transmitted by the audio input/output interface to realize connection between devices with different interfaces including the connection between a small electronic device and other small mobile electronic devices or fixed electronic devices, so that the relative data or information could be transmitted mutually. At the same time, the USB plug of the multiplexing transmission line provided by the present invention can be protected by adopting various hidden structures which are simple and are convenient to use, such as rotary, extensile or overturn style structure.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

1. A USB data-audio signal multiplexing transmission line, comprising connectors in both ends and a transmission wire for connecting a play device to another external data storage device or processing device to make data exchange or to output audio signal, wherein the connectors in both ends are respectively a USB connector and an audio connector, the USB connector includes a connector body and a USB connecting plug set on the body; an audio connecting plug set on the audio connector is divided into four electric-independent segments which are two audio signal connecting ends, an audio ground connecting end and a control signal connecting end in turn; the two audio signal connecting ends of the audio connecting plug are connected to two data signal connecting ends of the USB connecting plug respectively; the ground connecting end of the audio connecting plug is connected to a ground connecting end of the USB connecting plug; and the control signal connecting end of the audio connecting plug is connected to a power end of the USB connecting plug.

2. A USB data-audio signal multiplexing transmission line according to claim 1, wherein said USB connector body comprises a shell and a rotary body; the USB connecting plug is set on an end portion of the rotating body; the shell, with a perforation opened at the tail end through which the transmission wire is set, covers the rotating body; the rotary body is pin-jointed at the front end of the shell, and rotates around a pin-jointed point; and two sides of the shell serve as opens for the rotary body rotating through.

3. A USB data-audio signal multiplexing transmission line according to claim 1, wherein said USB connector body comprises a shell and an extension body; the USB connecting plug is set on an end portion of the extension body; the shell, with a perforation opened at the tail end through which the transmission wire is set, covers the extension body; the shell is set outside the extension body to cover the extension body; a bulge portion is located on a upper surface of the extension body; a slide groove is cut on the upper surface of the shell; and the bulge portion is embedded in the slide groove and slides along the slide groove to make the extension body flex in the shell.

4. A USB data-audio signal multiplexing transmission line according to claim 1, wherein said USB connector body comprises a combination body and a overturn body; one end of the combination body is pin-jointed to the overturn body, and the other end is connected to the transmission wire; a flaky USB connecting plug is set on the non-pin-jointed end of the overturn body; a groove is cut on the upper surface of the combination body and shape and size of the groove are corresponding to those of the overturn body.

5. A USB data-audio signal multiplexing transmission line according to claim 4, wherein an audio interface is set in said combination body.

6. A USB data-audio signal multiplexing transmission line according to claim 1, wherein said USB connector comprises a printed circuit board and an integrative-disposed USB interface connecting board; the printed circuit board is located inside the connector body, and the USB interface connecting board protrudes from the connector body and forms the flaky USB connecting plug together with a projecting bottom shell of the connector body; there is a set of metal terminals on the connecting board, the set of metal terminals consists of several metal sheets for connecting with the electronic signal in the USB slot; the metal sheets are coupled to the printed circuit board and form a circuit loop; a protrusion-strip-shaped protection frame sticks up from both sides of the bottom shell of said USB connecting plug; the USB interface connecting board is embedded into the bottom shell, with the side having the set of metal terminals upward as an exposed face; the size of the flaky USB connecting plug is same as that of inner space of the USB wire slot.

7. A USB data-audio signal multiplexing transmission line according to claim 6, wherein the setting range of said metal sheets is same as the length of the projecting USB interface connecting board, and the length of the metal sheets is same as or longer than that of a contact sheet for electrical connection inside the USB slot.

8. A USB data-audio signal multiplexing transmission line according to claim 6, wherein four metal sheets are set on the upper surface of said USB interface connecting board, which are coupled to a power wire, two data wires and a ground wire inside a USB connecting unit in turn; two metal sheets set on the lower surface; the middle two metal sheets of the upper surface connect to each other and also connect to two audio signal wires; said protection frame is correspondingly located on two sides of the USB interface connecting board; and the upper and lower surfaces of the board body are both exposed.

9. A USB data-audio signal multiplexing transmission line according to claim 6, wherein said set of metal terminals is divided into two groups; one group includes four metal sheets coupled to a power wire, two data wires and a ground wire inside a USB connecting unit in turn; the other group includes two metal sheets coupled to two audio signal wires of an audio connecting unit.

10. A USB data-audio signal multiplexing transmission line according to claim 1, wherein said USB connecting plug is plug style or receptacle style.

11. A USB data-audio signal multiplexing transmission line according to claim 1, wherein said USB connecting plug is large plug or small plug.

12. A USB data-audio signal multiplexing transmission line according to claim 1, wherein said audio connector is audio plug or audio receptacle.

13. A USB data-audio signal multiplexing transmission line according to claim 2, wherein said USB connector comprises a printed circuit board and an integrative-disposed USB interface connecting board; the printed circuit board is located inside the connector body, and the USB interface connecting board protrudes from the connector body and forms the flaky USB connecting plug together with a projecting bottom shell of the connector body; there is a set of metal terminals on the connecting board, the set of metal terminals consists of several metal sheets for connecting with the electronic signal in the USB slot; the metal sheets are coupled to the printed circuit board and form a circuit loop; a protrusion-strip-shaped protection frame sticks up from both sides of the bottom shell of said USB connecting plug; the USB interface connecting board is embedded into the bottom shell, with the side having the set of metal terminals upward as an exposed face; the size of the flaky USB connecting plug is same as that of inner space of the USB wire slot.

14. A USB data-audio signal multiplexing transmission line according to claim 3, wherein said USB connector comprises a printed circuit board and an integrative-disposed USB interface connecting board; the printed circuit board is located inside the connector body, and the USB interface connecting board protrudes from the connector body and forms the flaky USB connecting plug together with a projecting bottom shell of the connector body; there is a set of metal terminals on the connecting board, the set of metal terminals consists of several metal sheets for connecting with the electronic signal in the USB slot; the metal sheets are coupled to the printed circuit board and form a circuit loop; a protrusion-strip-shaped protection frame sticks up from both sides of the bottom shell of said USB connecting plug; the USB interface connecting board is embedded into the bottom shell, with the side having the set of metal terminals upward as an exposed face; the size of the flaky USB connecting plug is same as that of inner space of the USB wire slot.

15. A USB data-audio signal multiplexing transmission line according to claim 4, wherein said USB connector comprises a printed circuit board and an integrative-disposed USB interface connecting board; the printed circuit board is located inside the connector body, and the USB interface connecting board protrudes from the connector body and forms the flaky USB connecting plug together with a projecting bottom shell of the connector body; there is a set of metal terminals on the connecting board, the set of metal terminals consists of several metal sheets for connecting with the electronic signal in the USB slot; the metal sheets are coupled to the printed circuit board and form a circuit loop; a protrusion-strip-shaped protection frame sticks up from both sides of the bottom shell of said USB connecting plug; the USB interface connecting board is embedded into the bottom shell, with the side having the set of metal terminals upward as an exposed face; the size of the flaky USB connecting plug is same as that of inner space of the USB wire slot.
